(19) United States
(12) Patent Application Publication
(10) Pub. No.: US 2008/0116296 A1
(43) Pub. Date: May 22, 2008

(54) Spray gun

(76) Inventor: Chung-Tsuen Juo, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/603,026

(22) Filed: Nov. 22, 2006

(51) Int. Cl. B05B 1/02

(52) U.S. Cl. 239/338

(57) ABSTRACT

A spray gun which comprises a gun body and a nebulizing device attached to the front portion of the gun body, wherein the nebulizing device has an air nebulizing cap and a fluid disperser unit, wherein the nebulizing cap is composed of a fixed nut and a nebulizing nozzle while the fluid disperser unit is composed of a fluid nozzle and an air disperser unit, wherein the fluid nozzle has a threadless combining portion. Thus, through a linked push structure formed between the air nebulizing cap and the fluid disperser unit, the threadless combining portion can be pushed toward and therefore contacting the gun body.

### BACKGROUND OF THE INVENTION

1. Technical Field

The present invention relates to spray guns, and more particularly, to a spray gun with a structure in which a nebulizing device is combined with a gun body forming a nozzle with the threadless combining end of the nebulizing device pushed into the gun body contacting a fluid in the gun body.

2. Description of Related Art

Spray guns are popularly utilized for spraying coloring or protectively coating material on articles and have to be cleaned before color change or after use to avoid undesirable color intermixing. Such spray gun is typically assembled by means of screwing a fluid disperser unit and a paint delivering channel to a gun body.

FIG. 8 enumerates one of the conventional structures of spray guns. It can be seen that a nebulizing device 82 is to be assembled to a front portion 81 of a gun body 8, and a fluid disperser unit 83 is coupled with a fluid passage 85 equipped with a needle 84. Thus, it would be difficult to put forth effort on the peripheral surface of a head 831 of the fluid disperser unit 83, and a formulated tool may be required to hold a non-round part 832 of the fluid disperser unit 83 and disassemble the fluid disperser unit 83 from the fluid passage 85 for cleaning. The formulated tool is also necessary for assembling the fluid disperser unit 83 with the fluid passage 85 again. Such assembly and disassembly with tools can cause great inconvenience to a spray gun operator and therefore a need exists for a spray gun with improved structure that requires no tool when being assembled and disassembled.

### SUMMARY OF THE INVENTION

The present invention has been accomplished under the circumstances in view.

It is one object of the present invention to provide a spray gun with the fluid disperser unit assembled and communicated to the fluid control valve unit with a threadless combining portion thereof so that the fluid disperser unit can be assembled or disassembled from the fluid control valve without the assistance of a special tool.

It is another object of the present invention to provide a spray gun, in which a linked push structure is provided between an air nebulizing cap and the fluid disperser unit so that when the air nebulizing cap is combined with the gun body, the threadless combining end can be pushed to become communicated with the fluid control valve unit.

To achieve foregoing objects, the spray gun of the present invention is composed of a gun body and a nebulizing device attached to the front portion of the gun body whereby paint and air can be nebulized and formed into a predetermined spraying scope by the nebulizing device.

Said nebulizing device comprises an air nebulizing cap and a fluid disperser unit, wherein the nebulizing cap is composed of a fixed nut and a nebulizing nozzle while the fluid disperser unit is composed of a fluid nozzle and an air disperser unit.

Said fluid nozzle has one end thereof formed as a threadless combining portion. As a linked push structure is provided between the air nebulizing cap and the fluid disperser unit, the threadless combining portion can be pushed toward and therefore contacts the gun body when the air nebulizing cap is assembled to the gun body.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a partial cross sectional view of a first embodiment of the present invention;

FIG. 2 is an exploded view showing part of the assembly according to FIG. 1;

FIG. 3 is a sectional view of the nebulizing device according to FIG. 1;

FIG. 4 is a sectional view of the nebulizing device according to a second embodiment of the present invention;

FIG. 5 is an exploded view of the nebulizing device according to a third embodiment of the present invention;

FIG. 6 is a sectional view of the nebulizing device according to FIG. 4;

FIG. 7 is a sectional view of the nebulizing device according to a fourth embodiment of the present invention; and

FIG. 8 is an exploded view of the nebulizing device of a conventional spray gun.

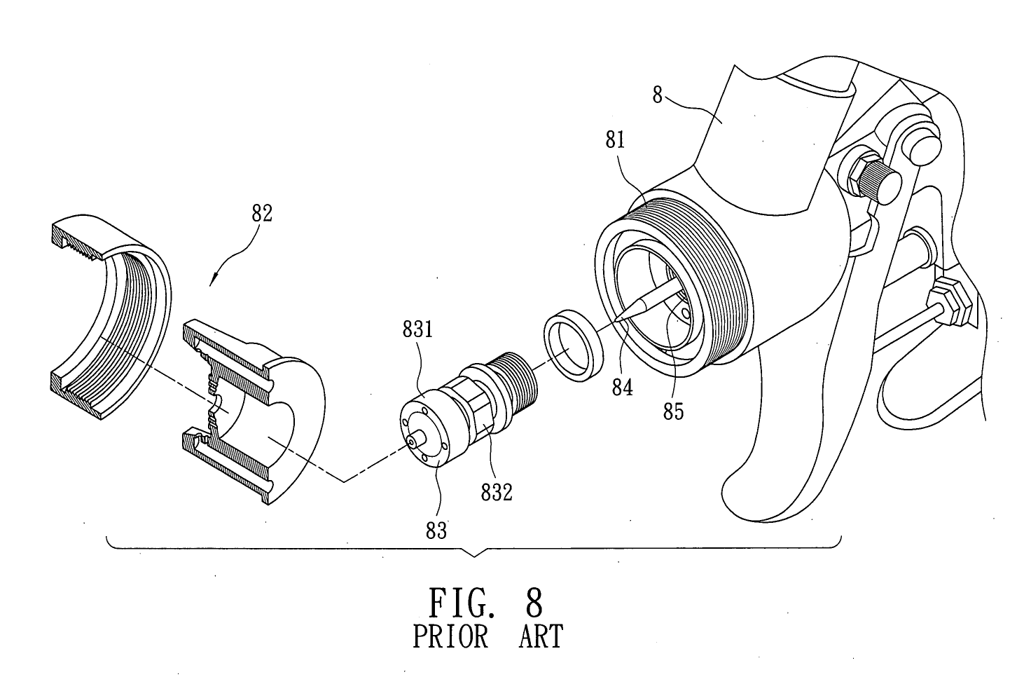

### DETAILED DESCRIPTION OF THE PREFERRED EMBODIMENT

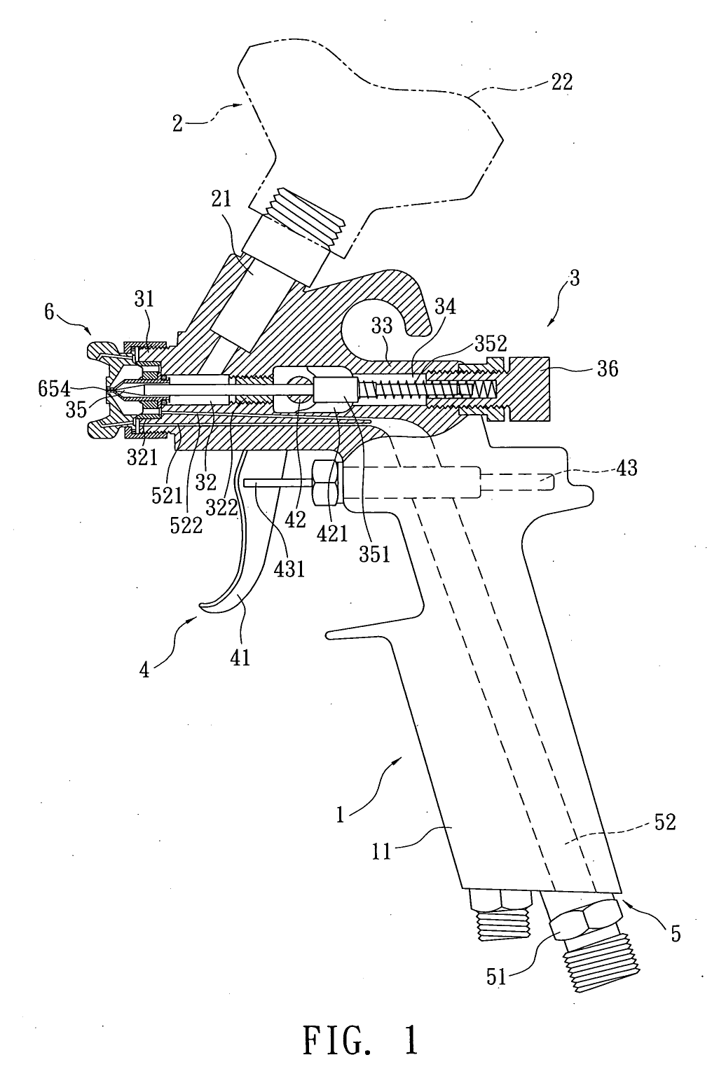

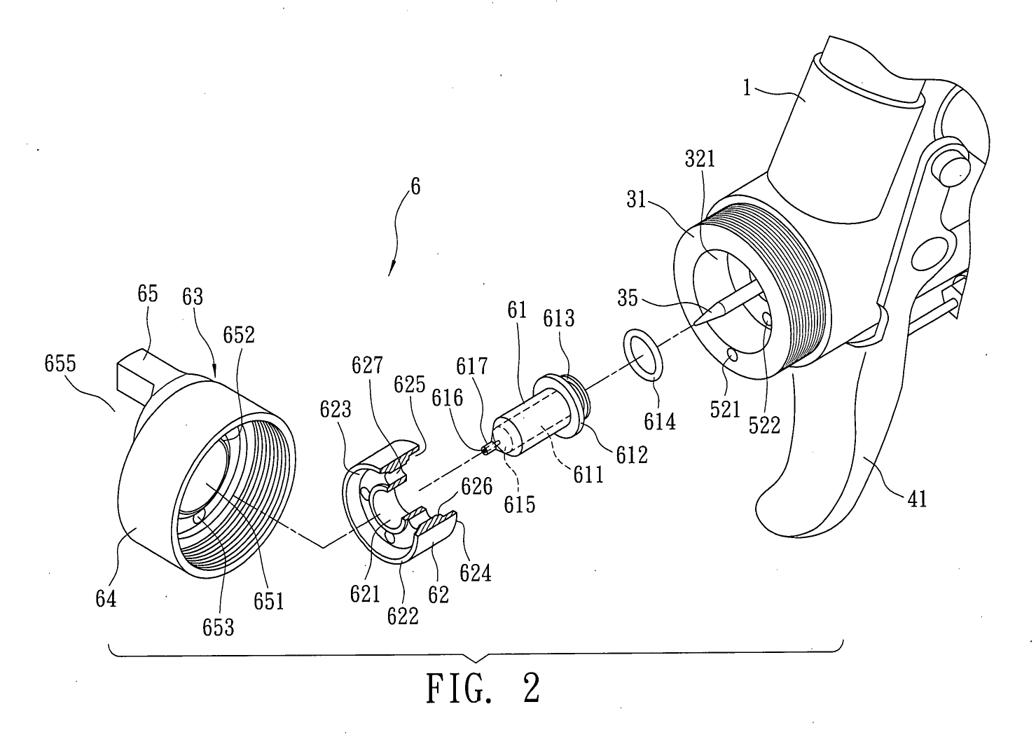

One embodiment of the spray gun according to the present invention has been depicted through FIGS. 1 to 3 of which the structure comprises a gun body 1 whereupon following components are provided:

a) a paint feeding unit 2, which includes a paint delivering channel 21 with one end detachably combined with a paint reservoir 22 in an airtight way while the other end fixedly fastened to the inside of the gun body 1;

b) a fluid control valve unit 3, which included a fluid passage 32 positioned at a front portion 31 of the gun body 1 and communicable with the paint delivering channel 21, a nebulizing area 321 adjacent to the front end of the fluid passage 32, a stopper 322 for making the rear end of the fluid passage 32 air-tight;

a needle 35 in a tapered shape which having a pressing part 351 which is diametrically enlarged in the middle portion thereof, an elastic element 352 which is closely compressed upon the pressing part 351 wherein the needle 35 is pierced from a threaded passage 34 located at the rear portion 33 of the gun body 1 through said fluid passage 32 and sticking out the front portion 31 by way of the nebulizing area 321; and

an adjusting nut 36, for receiving said elastic element 352 and being coupled with the threaded passage 34 wherein the elastic element 352 is compressed onto the adjusting nut 36, so that the needle 35 can be repositioned;

c) an operating unit 4, which includes a operational space 421 contained in the threaded passage 34 at the segment isolated from the fluid passage 32;

a trigger 41, which has one end thereof pivotally fastened to the gun body 1, a linked component 42 located within the operational space 421 and pierced by the needle 35 wherein the linked component 42 is compressing upon the pressing part 351 so that the trigger 41 can be repositioned;

an air control valve 43, which is settled inside the gun body 1, and having a push rod 431 stretching toward the trigger 41; and

d) an air delivering unit 5, which comprises a pipe connector 51 positioned at the bottom of a handle 11 of the gun body 1 and an air input passage 52 communicated to the pipe connector 51 and the air control valve 43, wherein the air input passage 52 is extending beyond the air control valve 43 and after the air control valve 43 forked into two channels, wherein one is a first air output passage 521 leading into the front portion 31 while the other is a second air output passage 522 leading into the nebulizing area 321; and

an nebulizing device 6, which is attached to the front portion 31 of the gun body 1, and can pivot on one end thereof connected to the gun body 1 anticlockwise when the trigger 41 is triggered and the needle 35 of fluid control valve unit 3 as well as the push rod 431 of air control valve 43 are pushed toward the rear portion 33 of the gun body 1 by the trigger 41, so that paint and high-pressure air are allowed to enter the nebulizing device 6, and the high-pressure air successively helps for nebulizing the paint to be sprayed.

Foresaid nebulizing device 6 further comprises:

a fluid nozzle 61, which has a central passage 611, an annular first driven part 612 located at one end of the central passage 611, a threadless combining end 613 and a washer 614 provided between the first driven part 612 and the threadless combining end 613 wherein the central passage 611 has the other end thereof positioned adjacent to a fluid converging area 615 and further contacting the fluid outlet 616;

an air disperser 62, which is in an annular shape and has a central through hole 621, a second drive part 622 with a depressed air converging area 623 at one side, an annular propping part 624 with a depressed air input area 625 and an accommodating part 626 at the other side, and at least one dispersing hole 627 provided for communicating both sides whereby the air disperser 62 can be put around the fluid nozzle 61 with the through hole 621 and have the first driven part 612 accommodated by the accommodating part 626; and

an nebulizing cap 63, which is detachably combined with the front portion 31 of the gun body 1 by means of a fixed nut 64 which is connected to a rotatable nebulizing nozzle 65 wherein the nozzle 65 has one side thereof rotatably inlayed into the fixed nut 64 and has an air converging area 651 which comprises an interacting part 652 at the periphery thereof for compressing upon the second driven part 622; and the nebulizing nozzle 65 further contains at least one first air outlet 653 for communicating the both sides thereof, a second air outlet 654 provided in the air converging area 651 at the opposite side of the nozzle 65 with respect to and correspondingly to the first air outlet 653, and a nebulizing area 655 defined between the first air outlet 653 and second air outlet 654.

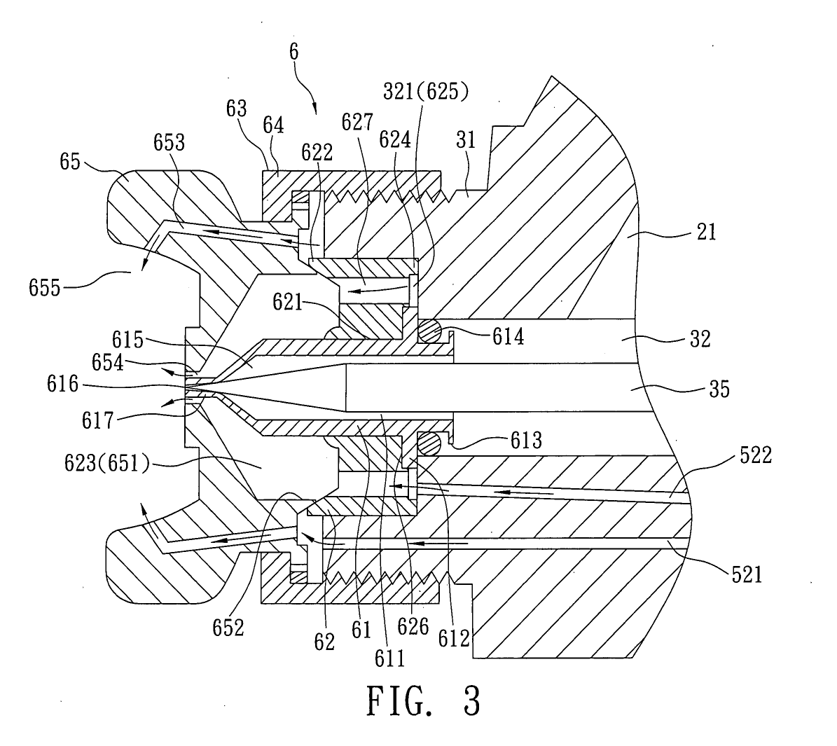

Thus, when the fluid nozzle 61 covered by the air disperser 62 with a nozzle head 617 thereof pierces into the second air outlet 654, the second air outlet 654, as can be seen in FIG. 3, has the shape thereof becoming an annular gap.

Further, a linked push structure is provided among the nebulizing cap 63, air disperser 62 and fluid nozzle 61 by screwing the fixed nut 64 to the gun body 1 whereby the interacting part 652 pushes the second drive part 622 toward the gun body 1 and the accommodating part 626 pushes the first driven part 612 in the same direction until the first driven part 612 comes into closely contact with the front portion 31.

Therefore, the central passage 611 can be communicated with the fluid passage 32 and the paint can be filled into the nozzle head 617 by way of the fluid converging area 615. At this time, since the fluid outlet 616 of the nozzle head 617 is obstructed by the tip of the needle 35 of the fluid control valve unit 3, the paint can be held from leaking.

Referring to FIG. 3, once the trigger 41 is pulled to affect the needle 35 of the fluid control valve unit 3 and the push rod 431 of air control valve 43, part of the high-pressure air can be led to the semi-closed air input area 625 through the second air output passage 522, guided to the air converging areas 623, 651 through the dispersing hole 627 and finally introduced into the annular-gap-shaped second air outlet 654 for further nebulizing the paint in the nebulizing area 655 in order to produce nebulized paint.

The rest high-pressure air is led to the semi-closed nebulizing area 321 through the first air output passage 521, and ejected from the first air outlet 653 to help spraying the nebulized paint within the nebulizing area 655 in a predetermined spraying scope.

The advantages of the present embodiment are as follows.
1. As to the combination with the fluid passage, the threadless combining end is implemented in the present embodiment to substitute for the conventional thread connection used in prior art. Thus the detachable combination between the fixed nut and the gun body permits the assembly and disassembly thereof can be easily realized without need of formulated tools.
2. The prior art spray gun needs to be screwed twice to assemble the nebulizing device, whereas according to the present embodiment, the assembly can be accomplished through a single screwing operation. Thus the present embodiment is advantageous by easy to be disassembled and cleaned and is obviously superior to the prior art.

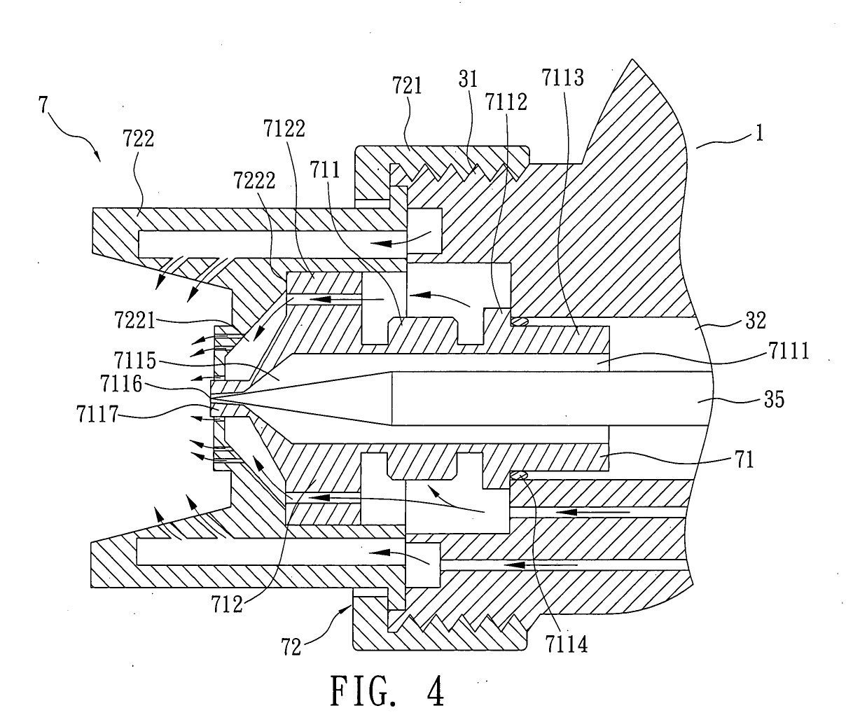

Certainly, there can be various embodiments according to the present invention. As a second embodiment of the present invention shown in FIG. 4, a nebulizing device 7 comprises a fluid disperser unit 71 and a nebulizing cap 72 wherein the fluid disperser unit 71 is composed of a fluid nozzle 711 and an air disperser ring 712 and is for being assembled to a nebulizing nozzle 722 settled in the nebulizing cap 72 and afterward the nebulizing device 7 can be detachably combined with a front portion 31 of the gun body 1.

The linked push structure between said fluid disperser unit 71 and nebulizing cap 72 is now varied because the fluid nozzle 711 and the air disperser ring 712 integratedly formed. In such structure, an air converging area 7221 of the nebulizing nozzle 722 has an annular interacting part 7222 for compressing upon a driven part 7122 provided at the periphery of the air disperser ring 712 to push a threadless combining end 7113 of the fluid nozzle 711 into the fluid passage 32 of gun body 1 until an annular propping part 7112 comes into contact with the front portion 31, and a washer 7114 is further provided to prevent paint leakage.

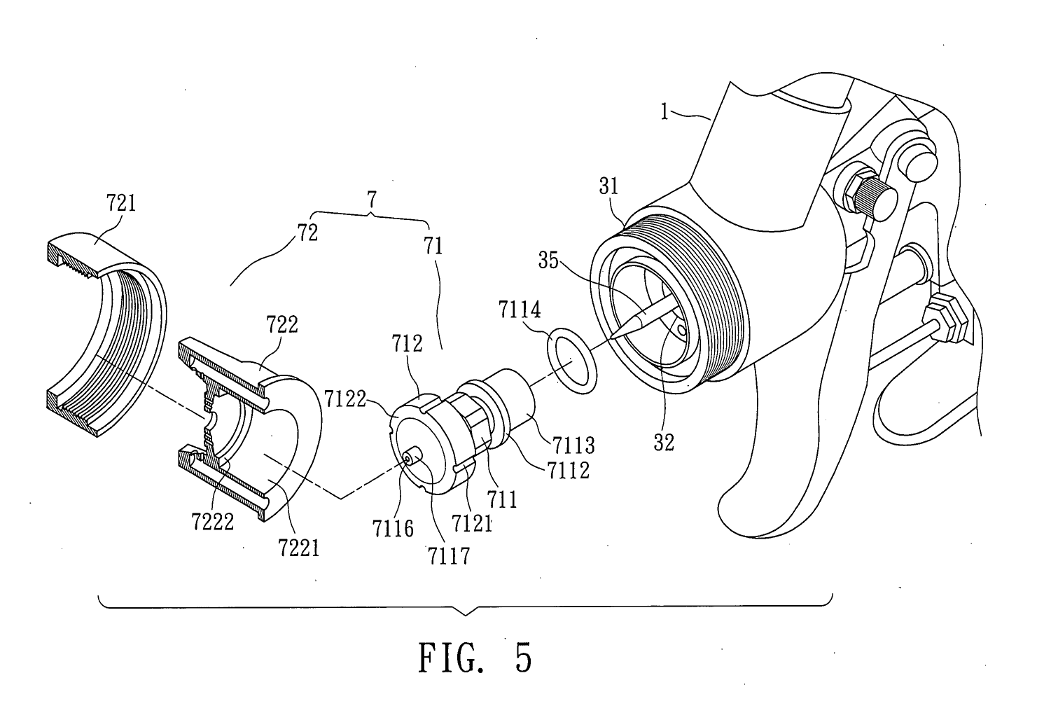

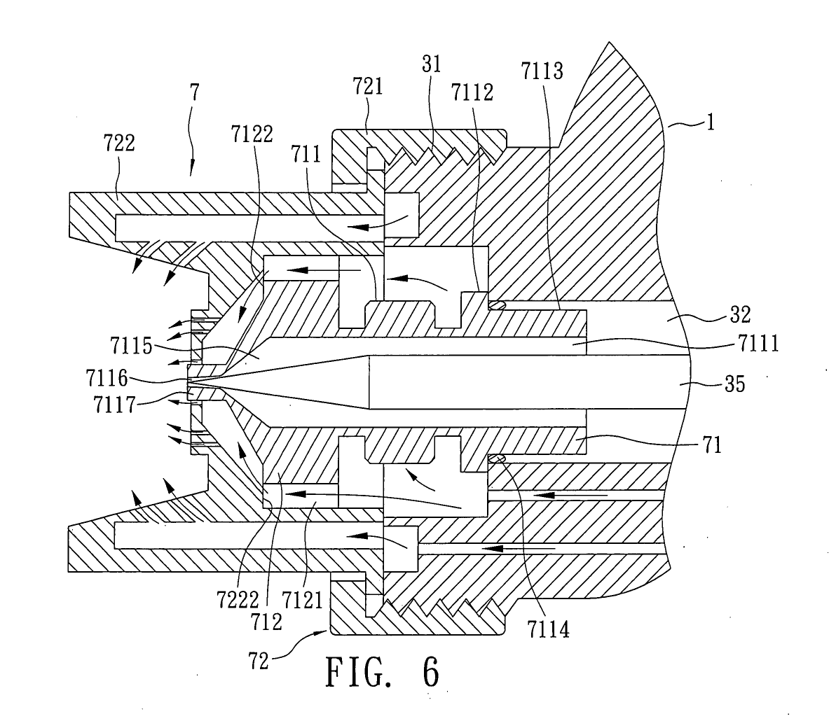

A third embodiment of the present invention is illustrated through FIGS. 5 and 6. In the present embodiment, at least one groove 7121 arranged at the periphery of the driven part 7122 is implemented to supersede foresaid dispersing hole 627.

The air disperser ring 712 is installed in an air converging area 7221 of the nebulizing nozzle 722 so that the driven part 7122 can compress upon the interacting part 7222 and between the groove 7121 and the inner wall of the air converging area 7221 a through channel can be defined. Thereby, the high-pressure air can enter the air converging area 7221 after being dispersed by the groove 7121.

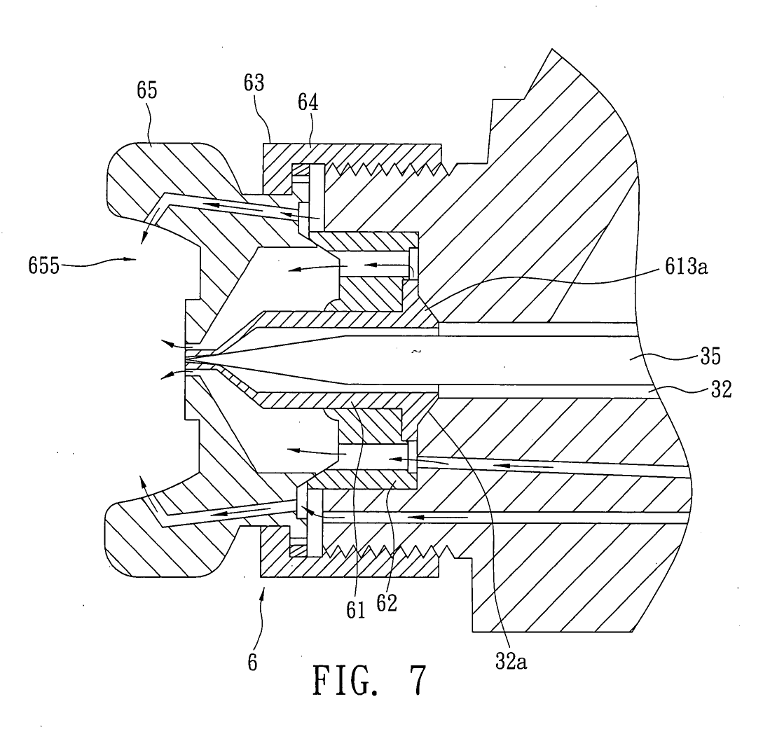

FIG. 7 is for explaining a fourth embodiment of the present. In the present embodiment, the fluid passage 32 with a end adjacent to a fluid nozzle 61 comprises a diametrically enlarged port 32a to receive a threadless combining portion 613a in a mated shape and provided on the fluid nozzle 61.

Again, a washer can be arranged between the threadless combining portion 613a and port 32a.

To sum up, the technical concept of the present invention is to realize the combination of the nebulizing device and gun body by pushing the threadless combining end of the air nebulizing cap into the fluid passage to make the fluid passage intercommunicated with a central passage of the air nebulizing cap. It is to be understood that though the air disperser 62 and the fluid nozzle 61 are present in separate parts while the air disperser ring 712 and the fluid nozzle 711 are formed integratedly, the dispersing hole 627 and the through channel defined between the groove 7121 and the inner wall of the nebulizing nozzle 722 perform the same function of allowing air passing and converging and therefore should be regarded as embodiments of the identical air disperser unit.

Although particular embodiments of the invention have been described in detail for purposes of illustration, it will be understood by those skilled in the art that numerous variations are possible to the disclosed embodiments without going outside the scope of the invention as disclosed in the following claims:

What is claimed is:

1. A spray gun which is composed of a gun body and a nebulizing device attached to a front portion of the gun body wherein the gun body comprises a paint feeding unit for leading paint into the gun body, a fluid control valve unit which is for leading said paint into the nebulizing device and retaining the paint within the nebulizing device by an adjustable and adjustable needle, an air delivering unit which injects air into the nebulizing device, and an operating unit, which includes an air control valve and a trigger for controlling the fluid control valve unit and the air delivering unit whereby the paint and air can be nebulizd with a predetermined spraying scope by the nebulizing device, wherein the nebulizing device comprises:
nebulizing cap which is composed of a fixed nut and a nebulizing nozzle, wherein the fixed nut is detachably combined with the front portion of the gun body to position the nebulizing nozzle at the front portion and the nebulizing nozzle comprises at least one first air outlet at the periphery thereof and a second air outlet at the center thereof;
a fluid disperser unit which is composed of a fluid nozzle and an air disperser unit wherein the air disperser unit has at least one fluid dispersing hole for making the two sides of the air disperser unit intercommunicated and the fluid nozzle having a nozzle head pierced into the second air outlet to make the second air outlet forming an annular gap; and
a central passage contacting the fluid control valve unit and positioned adjacent to a fluid converging area for further contacting the fluid outlet so that a through channel is formed to accommodate the needle for obstructing the fluid outlet and retaining the paint and is characterized by a threadless combining end provided on the fluid nozzle at one end adjacent to the fluid disperser thereof, and a linked push structure is provided between the air nebulizing cap and the fluid disperser unit so that the threadless combining end can be pushed to communicate with the fluid control valve unit when the air nebulizing cap is combined with the front portion of the gun body.

2. The spray gun of claim 1, wherein the fluid nozzle and the air disperser unit are two separated parts and the linked push structure provided therebetween comprises:
an interacting part settled on the air nebulizing cap;
a first driven part positioned at the periphery of the fluid nozzle;
a through hole, deposited at the center of the air disperser unit for being accommodating the fluid nozzle and compressed by the first driven part; and
a second driven part, provided at the opposite side of the air disperser unit with regard to the air nebulizing cap;
so that the interacting part can push the second driven part for further pushing the first driven part when the air nebulizing cap is assembled to the gun body.

3. The spray gun of claim 2, wherein a washer is provided between the first driven part and the threadless combining end.

4. The spray gun of claim 1, wherein the fluid nozzle and the air disperser unit formed integratedly and the linked push structure provided therebetween comprises:
an interacting part settled in the air nebulizing cap; and
a driven part positioned at the periphery of the air nozzle unit;
so that the interacting part can push the driven part when the air nebulizing cap is assembled to the gun body.

5. The spray gun of claim 4, wherein a propping part and a washer mounted thereon are provided between the air disperser unit and the threadless combining portion.

6. The spray gun of claim 1, wherein the structure of the fluid dispersing hole for intercommunicating the two sides is a through hole passing through the air disperser unit.

7. The spray gun of claim 1, wherein the structure of the fluid dispersing hole for intercommunicating the two sides is formed by putting the air disperser unit with a groove provided at the periphery thereof into the nebulizing nozzle to form a through channel that makes the two sides of the air disperser unit connect mutually between the inner wall of the nebulizing nozzle and the air disperser unit.
